(19) United States
(12) Patent Application Publication
(10) Pub. No.: US 2008/0163505 A1
(43) Pub. Date: Jul. 10, 2008

(54) Laser Indicated Pneumatic Cutter

(76) Inventor: Chin-ho Hsu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/621,266

(22) Filed: Jan. 9, 2007

(51) Int. Cl. G01C 15/00; B26D 7/00

(52) U.S. Cl. 33/286; 83/520

(57) ABSTRACT

A laser indicated pneumatic cutter includes a laser indicator fixed to a tooling head of a body. The laser indicator includes a transmission member, cells, and a switch lid behind the cells. A push button is provided on the switch lid. The cells and the transmission member are conducted to emit laser beam when the push button is pressed to align at a cutting line on a plate work piece to guide the cutting.

### BACKGROUND OF THE INVENTION

(a) Field of the Invention

The present invention relates to a pneumatic cutter, and more particularly, to one fixed with a laser indicator to emit laser beam aligned at a cutting line on a plate work piece to guide the cutting.

(b) Description of the Prior Art

Whereas there are many types of pneumatic tools generally available in the market, they operate by producing eccentric movement with air pressure to drive a tooling head to process cutting on a plate work piece. Before the process, a cutting line is usually drawn on the work piece for the tooling head to align at the line to guide the cutting operation. However, the prior art is found with a major flaw in failing a precise cutting. During the cutting, the tooling head is located at the most front of the pneumatic tool and is hidden from the view by the tooling head; the operator fails to cut or drill by faithfully following the cutting line since the operator's view is obstructed, leading to deviation of the cutting and waived work piece.

### SUMMARY OF THE INVENTION

To correct the problem of deviation due to failure in aligning at the cutting line found with the prior art, the primary purpose of the present invention is to provide a pneumatic cutter adapted with a laser indictor to guide the cutting. To achieve the purpose, the present invention comprises a body having a tooling head, a drive unit built in the body, and a work unit built in the body and driven by the drive unit; a locating section is provided on the tooling head and a slot is disposed on the locating section; the laser indicator provided on the locating section of the body includes a transmission member, cells, and a switch lid; a push button is disposed on the switch lid; an opening is provided at one end of the laser indicator opposite to the end where the switch lid is provided; and a locating plate provided on the laser indicator has through holes for fasteners to pass to lock the laser indicator to the tooling head of the body with nuts.

The body is in the shape of a straight rod.

The tooling head is a cutting head.

A spring is provided between the transmission member and the cells, and a sleeve is provided in the laser indicator.

The present invention provides the following advantages:
1. It emits laser beam to guide the cutter to align at a cutting line on a work piece to execute precise cutting without deviation; and
2. It is handy and provides excellent interchangeability since it may be adapted to various types of pneumatic tool.

### BRIEF DESCRIPTION OF THE DRAWINGS

FIG. 1 is an exploded view of a preferred embodiment of the present invention.

FIG. 2 is a perspective view of the preferred embodiment of the present invention as assembled.

FIG. 3 is a sectional view of the assembly of the preferred embodiment of the present invention.

FIG. 4 is a schematic view showing the preferred embodiment of the present invention in an operating status.

### DETAILED DESCRIPTION OF THE PREFERRED EMBODIMENT

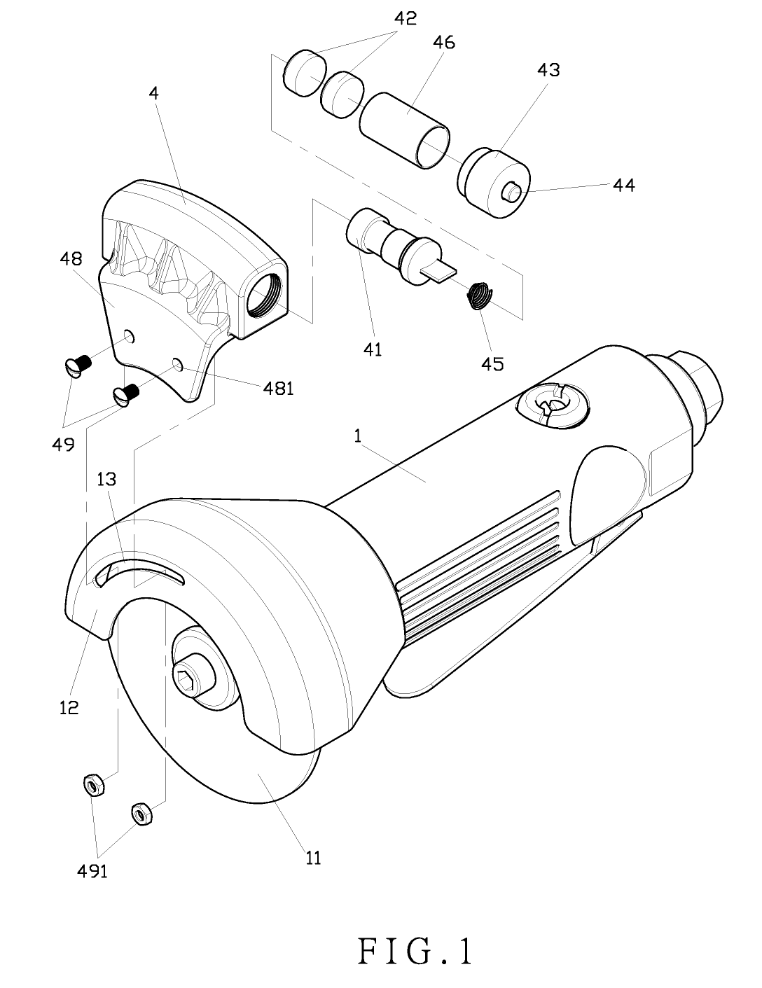

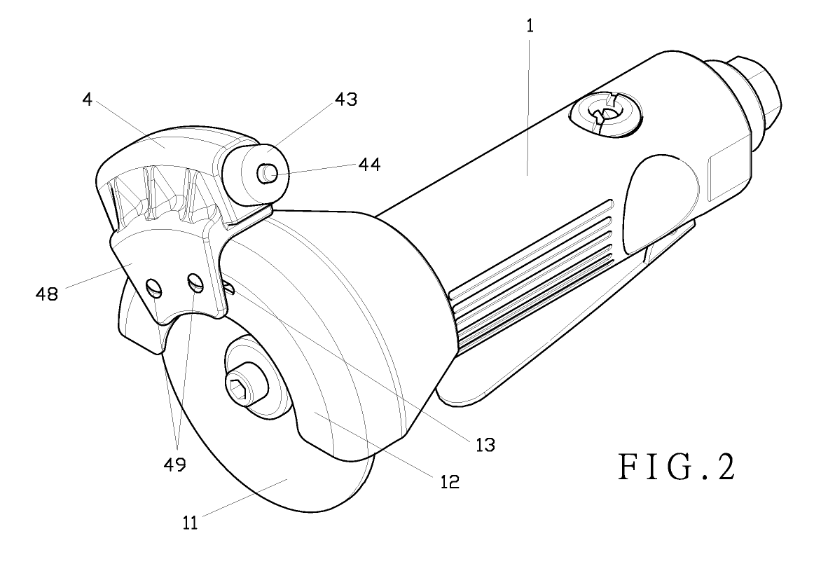

Referring to FIGS. 1 and 2, a preferred embodiment of the present invention comprises a body (1), a drive unit (2), a work unit (3), and a laser indicator (4).

The body (1) is in the shape of a straight rod. A tooling head (11) is provided at a front end of the body (1). In this embodiment, the tooling head (11) is a cutting head. A locating section (12) is provided on the top of the tooling head (11). An arc slot (13) is disposed on the locating section (12).

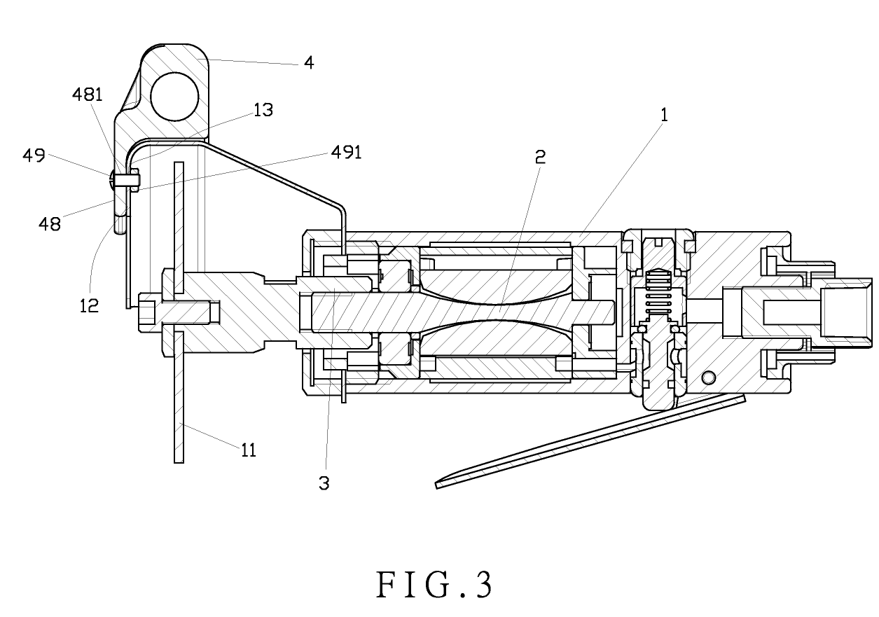

As illustrated in FIG. 3, the drive unit (2) is built in the body (1) to produce eccentric motion when subject to air pressure.

The work unit (3) is also built in the body (1) and driven by the drive unit (2) to further drive the tooling head (11) of the body (1) to create rotation for cutting.

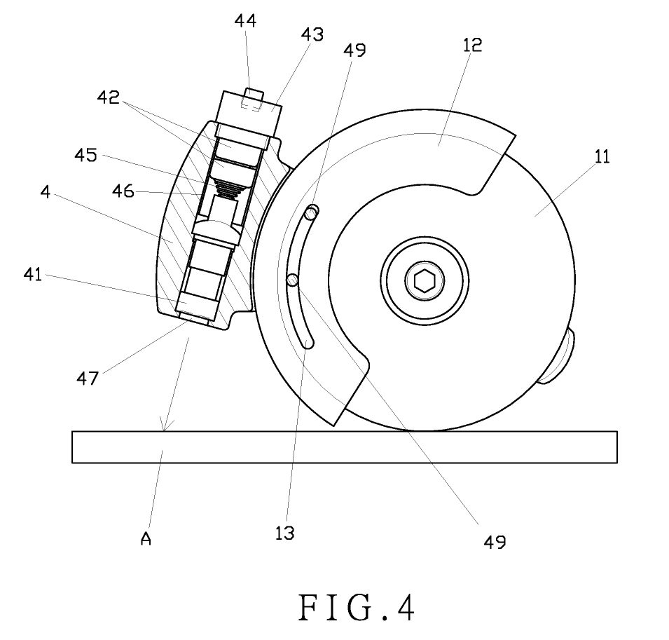

The laser indicator (4) provided on the locating section (12) of the body (1) comprises a transmission member (41), cells (42), and a switch lid (43) behind the cells (42) to locate and seal up the laser indicator (4). A push button (44) is provided on the switch lid (43) to conduct the cells (42) and the transmission member (41) to emit laser beam when pressed. A spring (45) is provided between the transmission member (41) and the cells (42), and a sleeve (46) is provided in the laser indicator (4). On one end opposite to where the switch lid (43) is provided on the laser indicator (4), an opening (47) is provided as illustrated in FIG. 4 to allow the laser beam emitted from the transmission member (41) to transmit through. A locating plate (48) is provided on one side of the laser indicator (4). Through holes (481) are provided on the locating plate (48) for fasteners (49) to pass to lock the laser indicator (4) to the tooling head (11) by means of nuts (491).

To assemble the present invention as illustrated in FIGS. 2 and 3, the transmission member (41) is placed in the laser indicator (4) by aligning right at the opening (47); the spring (45), the cells (42), the sleeve (46) and the switch lid (43) are placed in sequence in the rear of the laser indicator (4) for the switch lid (43) to be located to and seal up the laser indicator (4). The through holes (481) on the locating plate (48) of the laser indicator (4) correspond in position to the slot (13) of the body (1). The fasteners (49) pass the through holes (481) and the slot (13) before being engaged by the nuts (491). The laser indicator (4) is secured to the tooling head (11) of the body (1) to complete the assembly.

Now referring to FIG. 4, the tooling head (11) of the body (1) is reading to process cutting operation on a plate work piece (A). The body (1) is connected to an air pressure source (the connection is prior art and will not be elaborated here). The push button (44) on the switch lid (43) is pressed to conduct the cells (42) to produce electric power for activating the laser indicator (4) to emit laser beam from the transmission member (41). The laser beam is aligned at a cutting line on the plate work piece (A) for the cutter to proceed cutting step by step. The operator follows the guide by the laser beam to achieve precise cutting without any deviation whether the tooling head (11) is blocked from view by the body (1) or not.

What is claimed is:

1. A laser indicated pneumatic cutter, comprising:
a body having a tooling head;
a drive unit built in the body;
a work unit built in the body and driven by the drive unit; and characterized by:
a locating section being provided on the tooling head, the locating section having a slot;
a laser indicator provided on the locating section of the body, the laser indicator comprising a transmission member, cells and a switch lid, a push button being provided on the switch lid, the laser indicator having an opening at one end corresponding to the transmission member, a locating plate being provided on the laser indicator, through holes being provided on the locating plate for fasteners passing the through holes to lock the laser indicator to the tooling head with nuts.

2. The laser indicated pneumatic cutter as claimed in claim 1, wherein the body is in the shape of a straight rod.

3. The laser indicated pneumatic cutter as claimed in claim 1, wherein the tooling head is a cutting head.

4. The laser indicated pneumatic cutter as claimed in claim 1, wherein a spring is provided between the transmission member and the cells, and a sleeve is provided in the laser indicator.
